(19) United States
(12) Patent Application Publication
(10) Pub. No.: US 2022/0211195 A1
(43) Pub. Date: Jul. 7, 2022

(54) Mounting Assembly

(71) Applicants: Leith MORRISS, Moorooka (AU); Natalie LANE, Moorooka (AU)

(72) Inventors: Leith MORRISS, Moorooka (AU); Natalie LANE, Moorooka (AU)

(21) Appl. No.: 17/706,988

(22) Filed: Mar. 29, 2022

Related U.S. Application Data
(63) Continuation of application No. 16/677,052, filed on Nov. 7, 2019.

(30) Foreign Application Priority Data
Nov. 7, 2018 (AU) 2018904246

(51) Int. Cl. A47G 1/16

(52) U.S. Cl. CPC A47G 1/1686

(57) ABSTRACT

A mounting assembly is provided comprising at least one elongate mount comprising a longitudinal recess extending at least partially therealong; and a length of compressible material that is complimentary with said longitudinal recess and adapted to be received in frictional engagement therein, thereby securely retaining a sheet of material positioned in said longitudinal recess

### CROSS-REFERENCE TO RELATED APPLICATION

This application is a Continuation of U.S. application Ser. No. 16/677,052, filed Nov. 7, 2019, which claims priority to Australia Application Serial Number 2018904246, filed on Nov. 7, 2018, the entire disclosures of which are hereby incorporated by reference herein.

### FIELD

The present invention relates to a mounting assembly for mounting a sheet of material, such as a photograph or piece of artwork. The mounting assembly comprises at least one elongate mount having a longitudinal recess extending at least partially therealong and a length of compressible material that is complimentary with the longitudinal recess. In use, a portion of the sheet of material is placed in the longitudinal recess and the length of compressible material placed in the longitudinal recess, in frictional engagement, thereby securely retaining the sheet of material in the longitudinal recess

### BACKGROUND ART

Existing mounting assemblies, such as hangers for posters or photograph mounts, can suffer from various problems including:
A limited capacity to hold mediums of different thicknesses, resulting in thick paper or card posters or photographs dropping off walls as magnets or other securing means fail;
Being difficult to use, which can result in display pieces being damaged as users try to position the display pieces precisely, or when they apply forces during installation that are too demanding on the pieces; and
Deteriorating in their holding strength over time.

Moreover, many existing mounting assemblies use magnets, screws or other mechanical means to hold the photograph or artwork to one, or between two mounting ‘bars’. These point loads can dent, warp or distort the photograph or artwork, either by denting the material of the photograph or artwork directly or by stretching the material as it hangs from the few hold points.

The subject matter claimed herein is not limited to embodiments that solve any disadvantages or that operate only in environments such as those described above. Rather, this brief background is only provided to illustrate exemplary technology areas where some embodiments described herein may be practiced.

Various aspects and embodiments of the invention will now be described.

### SUMMARY

As mentioned above, the present invention relates generally to a mounting assembly that comprises at least one elongate mount having a longitudinal recess extending at least partially therealong and a length of compressible material that is complimentary with the longitudinal recess, the length of compressible material retaining a sheet of material in the longitudinal recess in use.

According to one aspect of the invention there is provided a mounting assembly comprising:
at least one elongate mount comprising a longitudinal recess extending at least partially therealong; and
a length of compressible material that is complimentary with the longitudinal recess and adapted to be received in frictional engagement therein, thereby securely retaining a sheet of material positioned in the longitudinal recess.

While it is envisaged the longitudinal recess may be defined by two or more recesses disposed along the length of the elongate mount, in a preferred embodiment the longitudinal recess preferably extends along the length of the elongate mount. The elongate mount may have closed ends, the longitudinal recess extending between the closed ends. In an alternative embodiment, the elongate mount has open ends with the longitudinal recess extending to the open ends.

The longitudinal recess may take any suitable form, for example it may have a substantially U-shaped cross-section, or may have inner walls that diverge from each other to a floor of the longitudinal recess. Preferably, the longitudinal recess has a rectangular cross-section.

The location of the longitudinal recess on the width of the elongate mount will be somewhat dependent on the width of the elongate mount. For example, if the mounting assembly defines mount for retaining a relatively rigid sheet of material (e.g. a photograph) extending upwardly from the mounting assembly, the width of the elongate mount may be relatively large so as to provide stability when seated on a surface. In that instance, the elongate recess may be located towards a rear wall of the elongate mount. In a preferred embodiment, in which the mounting assembly is intended as a hanging mount, the longitudinal recess is located substantially mid-way across the width of the elongate mount.

The elongate mount is preferably substantially rectangular in cross-section with the longitudinal recess extending along a longitudinal edge thereof. In a particularly preferred embodiment, the elongate mount comprises a longitudinal lip extending along a longitudinal side of the elongate mount. In certain embodiments, an outward facing surface of the longitudinal lip is contiguous with an outward facing surface of the elongate mount and an inward facing surface of the elongate lip is contiguous with an inner surface of the longitudinal recess. The protruding lip advantageously protects the sheet of material, or display piece, from creasing and damage around the edge of the elongate recess during installation. This also facilitates ease of placement of the length of compressible material into the elongate recess, for example by pressing and sliding it against the display piece supported by the elongate lip.

In a preferred embodiment, the length of compressible material is complimentary to the longitudinal recess in length and width. In situ, the length of compressible material may be hidden in the longitudinal recess, or may include knots on one or both ends thereof that extend past ends of the longitudinal recess, or may include knots on ends thereof that are captured in retaining apertures located at opposing ends of the longitudinal recess.

The length of compressible material is preferably flexible so that it can be pushed into the elongate recess along its length gradually from one end to the other by the user applying light pressure perpendicular to the elongate recess. The final holding pressure on the display piece accumulates such that it is much higher than the momentarily applied installation pressures, thereby securely holding the display piece and permitting accommodation of a greater range of display piece thicknesses than some alternative mounting arrangements.

The size, shape, compressibility and other characteristics of the length of compressible material can be selected to further accommodate display pieces of varying thicknesses and materials, this permits users to use one type of hanger for different types of display pieces. While it is envisaged that rubber or other materials may be used, it has been found that round cotton cord is a particularly effective option for installing both thin paper and thicker card display pieces in the same hanger.

From the above description it should be appreciated that according to the preferred embodiments of the invention the continuous, and therefore lighter, holding pressure of the sheet of material, for example artwork or photograph, within the mounting assembly provides significant advantages.

The mounting assembly may further comprise a mounting arrangement on an external surface thereof for mounting the mounting assembly on a wall. For example, the mounting arrangement may comprise a mounting aperture adapted to be mounted on a mounting point on the wall, such as a screw or nail protruding from the wall, or may comprise a hook-and-loop fastener such as Velcro® tabs located on the external surface that are complimentary with Velcro® tabs located on the wall.

In certain embodiments, the compressible material may comprise a loop of compressible material that extends along the longitudinal recess and continues to define a hanging cord to facilitate hanging of the mounting assembly. According to this embodiment, the compressible material preferably comprises round cotton cord.

In certain embodiment, the mounting assembly comprises a pair of the elongate mounts and a pair of associated complimentary lengths of compressible material, wherein in situ the pair of elongate mounts are located relative to one another by the sheet of material, retained therebetween. That is, the pair of elongate mounts are disposed on top and bottom edges of the sheet of material such that the sheet of material hangs between the pair of elongate mounts.

While the invention is not so limited, for environmental and aesthetic reasons, the elongate mount is preferably formed from renewable and/or recyclable materials. In a particular embodiment of the invention the elongate mount is formed from timber.

### BRIEF DESCRIPTION OF DRAWINGS

Embodiments of the invention will be described and explained with additional specificity and detail through the accompanying drawings in which:

FIG. 1 illustrates a side perspective view of a mounting assembly according to one embodiment of the invention, in which the mounting assembly includes a pair of elongate mounts.

FIG. 2 illustrates a side view of the mounting assembly of FIG. 1.

FIG. 3 illustrates a front view of the mounting assembly of FIG. 1 substantially prior to assembly.

FIG. 4 illustrates mounting arrangements of certain embodiments of the mounting assembly.

FIG. 5 illustrates an alternative mounting arrangement which utilises a loop of round cotton cord.

FIG. 6 illustrates an example in which the elongate lip is mounted flush to the wall.

FIG. 7 illustrates a side perspective view of a mounting assembly that is intended for placement on a surface, rather than as a hanging mount.

### DETAILED DESCRIPTION

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

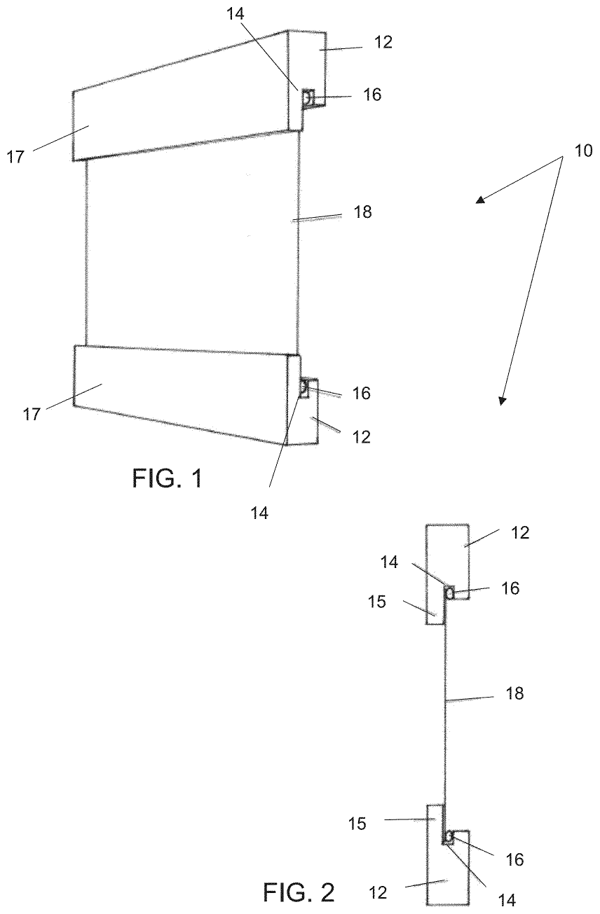

Referring to FIGS. 1 to 3, a mounting assembly 10 is illustrated. The mounting assembly 10 includes elongate mounts 12, each of which includes a longitudinal recess 14 and an elongate lip 15. Each elongate recess 14 contains a length of compressible material 16 extending along the length of the longitudinal recess 14. In this embodiment, the elongate mounts have open ends and the length of compressible material 16 is hidden within the longitudinal recess 14. The elongate lip 15 extends from one side of the elongate mount 12 forming a contiguous outer surface 17. Frictional engagement of each length of compressible material 16 within a respective longitudinal recess 14 retains a sheet of material 18 in position.

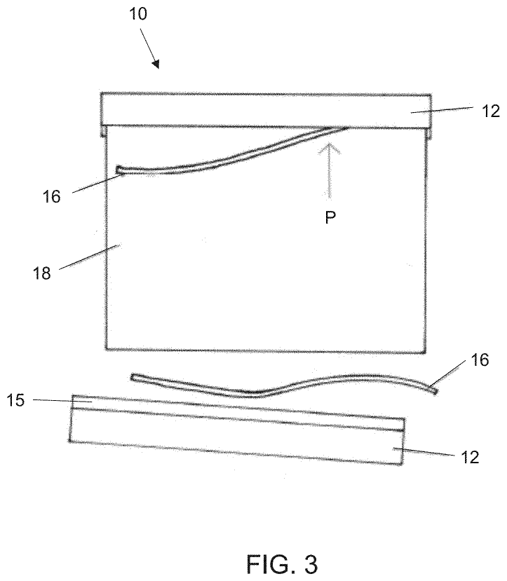

With particular reference to FIG. 3, the sheet of material 18 can be retained within the mounting assembly 10 by first placing an edge of the sheet of material 18 in a first of the elongate mounts 12 and pressing an end of the length of compressible material 16 into one end of the elongate recess 14 of the first of the elongate mounts 12. Pressure is then applied in direction P along the length of the compressible material 16 until it is completely pressed within the elongate recess 16, thereby retaining the sheet of material 18 in the elongate recess 16 of the first of the elongate mounts 12. Once the first edge is retained, the same process is followed to retain the opposite edge of the sheet of material 18 in a second of the elongate mounts 12.

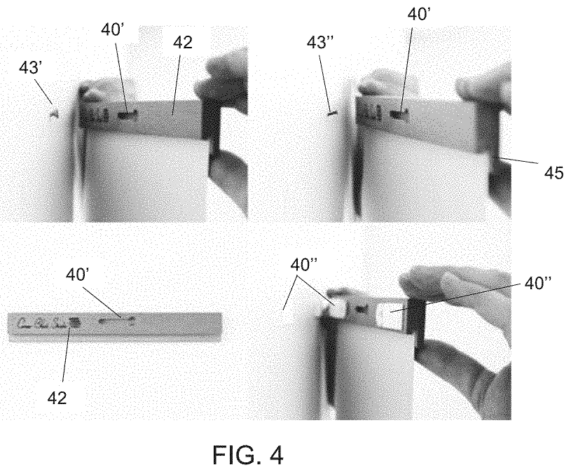

Referring to FIG. 4, a number of alternative mounting arrangements are illustrated. In one embodiment, the mounting arrangement consists of a slot 40′ located on a surface of the elongate mount 42. According to this embodiment, the elongate mount 42 can be mounted to a wall by locating the slot 40′ on a screw 43′ or nail 43″. In an alternative embodiment a hook-and-loop fastener such as Velcro® tabs 40″ are used.

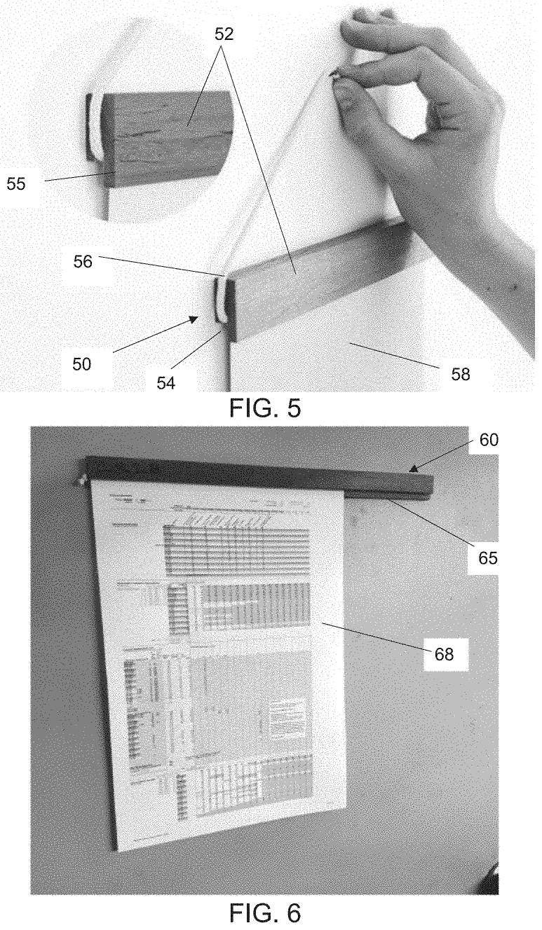

FIG. 5 illustrates another alternative mounting arrangement. In this arrangement a loop of round cotton cord 56 is provided. The loop of round cotton cord 56 retains a sheet of material 58 in an elongate recess 54 of the elongate mount 52 and also acts to hang the mounting assembly 50.

In the embodiments illustrated in FIGS. 4 and 5, the elongate lip 45, 55 of the elongate mount 42, 52 faces outwardly, away from the wall. It should also be understand that the opposite mounting on the wall may also be appropriate. FIG. 6 illustrates a mounting assembly 60 which is mounted to the wall in this fashion. As will be appreciated with reference to FIG. 6, the elongate lip 65 is flush against the wall. This may be advantageous in situations where the sheet of material 68 is to be exchanged regularly in that this mounting makes removal and replacement of the sheet of material 68 easier.

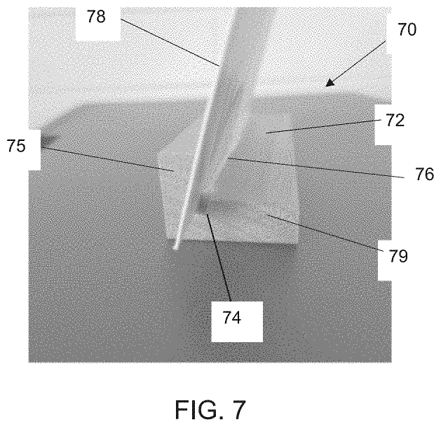

As previously described, the mounting assembly need not be a hanging mount, but may instead be a mount for placement on a surface. Referring to FIG. 7, a mounting assembly 70 is illustrated which includes an elongate mount 72 that includes an elongate recess 74 and an elongate lip 75. A length of compressible material 76 is disposed in the elongate recess and retains a sheet pf material 78 in the elongate recess 74. In this embodiment, it will be appreciated that the base 79 of the elongate mount 72 is larger than the hanging versions of the mounting assembly to provide more stability to the surface adapted mounting assembly 70.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

Unless the context requires otherwise or specifically stated to the contrary, integers, steps or elements of the invention recited herein as singular integers, steps or elements clearly encompass both singular and plural forms of the recited integers, steps or elements.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A mounting assembly comprising:
at least one elongate mount comprising a longitudinal recess extending at least partially therealong; and
a length of compressible material that is complimentary with said longitudinal recess and adapted to be received in frictional engagement therein, thereby securely retaining a sheet of material positioned in said longitudinal recess.

2. The mounting assembly according to claim 1, wherein the longitudinal recess extends along the length of the elongate mount.

3. The mounting assembly according to claim 1, wherein the elongate mount has closed ends with the longitudinal recess extending between said closed ends, or open ends with the longitudinal recess extending to the open ends.

4. The mounting assembly according to claim 1, wherein said longitudinal recess has a rectangular cross-section.

5. The mounting assembly according to claim 1, wherein said longitudinal recess is located substantially mid-way across the width of the elongate mount.

6. The mounting assembly according to claim 1, wherein a longitudinal lip extends along a longitudinal side of the elongate mount.

7. The mounting assembly according to claim 6, wherein an outward facing surface of the longitudinal lip is contiguous with an outward facing surface of the elongate mount and an inward facing surface of the elongate lip is contiguous with an inner surface of said longitudinal recess.

8. The mounting assembly according to claim 1, wherein said length of compressible material is complimentary to the longitudinal recess in length and width.

9. The mounting assembly according to claim 1, wherein in situ the length of compressible material is hidden in said longitudinal recess, or includes knots on one or both ends thereof that extend past ends of the longitudinal recess, or includes knots on ends thereof that are captured in retaining apertures located at opposing ends of the longitudinal recess.

10. The mounting assembly according to claim 1, wherein said length of compressible material comprises a length of round cotton cord.

11. The mounting assembly according to claim 1, further comprising a mounting arrangement on an external surface thereof for mounting the mounting assembly on a wall.

12. The mounting assembly according to claim 11, wherein said mounting arrangement comprises a mounting aperture adapted to be mounted on a mounting point on the wall, such as a screw or nail protruding from the wall, or comprises a hook-and-loop fastener, such as Velcro® tabs located on said external surface that are complimentary with Velcro® tabs located on the wall.

13. The mounting assembly according to claim 11, wherein said compressible material comprises a loop of compressible material that extends along said longitudinal recess and continues to define a hanging cord to facilitate hanging of said mounting assembly.

14. The mounting assembly according to claim 13, wherein said compressible material comprises round cotton cord.

15. The mounting assembly according to claim 1, comprising a pair of said elongate mounts and a pair of associated complimentary lengths of compressible material, wherein in situ said pair of elongate mounts are located relative to one another by said sheet of material, retained therebetween.

16. The mounting assembly according to claim 1, wherein said elongate mount is formed from renewable and/or recyclable materials.

17. The mounting assembly according to claim 16, wherein the elongate mount is formed from timber.
